(19) United States
(12) Patent Application Publication
(10) Pub. No.: US 2023/0195712 A1
(43) Pub. Date: Jun. 22, 2023

(54) Updates of Navigation Databases

(71) Applicant: THALES, Courbevoie (FR)

(72) Inventors: Stéphanie CARPENTIER, Cugnaux (FR); Dorian MARTINEZ, Toulouse (FR); Hugo BORONAT, Toulouse (FR)

(21) Appl. No.: 17/909,742

(22) PCT Filed: Feb. 18, 2021
(86) PCT No.: PCT/EP2021/054029

§ 371 Date: Feb. 27, 2023

(30) Foreign Application Priority Data
Mar. 10, 2020 (FR) FR2002342

(51) Int. Cl. G06F 16/23; G06F 16/28; G06F 16/29

(52) U.S. Cl. CPC G06F 16/23; G06F 16/287; G06F 16/29

(57) ABSTRACT

Computer-implemented devices and methods for analysing navigation databases are provided, particularly including the steps of: comparing two databases and determining a list of different procedures between the databases (referred to as deviations); describing one or more of these procedures by N distinct flight scenarios, corresponding to different combinations of variations in flight parameter values (combinations of variations in performance, meteorological and/or speed parameters); in an aeronautical computer e.g. FMS, for one flight scenario, determining one or more flyable trajectories associated with one (or more or each) ΔP procedure. Developments describe determining operational impacts, machine learning processes, analyses of deviation by trajectory, by procedure or by deviations between procedures. System and software aspects are described.

### CROSS-REFERENCE TO RELATED APPLICATIONS

This application is a National Stage of International patent application PCT/EP2021/054029, filed on Feb. 18, 2021, which claims priority to foreign French patent application No. FR 2002342, filed on Mar. 10, 2020, the disclosures of which are incorporated by reference in their entirety.

### FIELD OF THE INVENTION

The document relates to the field of navigation systems in general and in particular to that of methods and systems for analyzing the operational impact of updates of navigation databases e.g. NAVDB.

### BACKGROUND

Navigation databases contain, among other data, departure and arrival procedures at airports. One variety of navigation database is the NAVDB database, which is supplied by data providers in the A424 format, then put into the binary format (“packed”) by flight management system (FMS) providers, or by the data provider itself, and then used by the FMS to assist in particular in the operation of navigation functions. A NAVDB navigation database contains a great deal of data (in the order of magnitude of 500 000 procedures).

It happens that this type of database is regularly updated (a cycle referred to as “Airac”): around 10% of the data are updated every 28 days. Many technical problems then arise. For example, how may direct and induced modifications be detected in the navigation database? How may it be easily ensured that NAVDB modifications made do not lead to a trajectory proposed to the pilot on the ground or in flight being erroneous?

At present, certain known methods involve performing manual analyses on the input data. These analyses, when carried out on the A424 data source, show the direct modifications for the database, but do not show the induced modifications. Certain induced modifications may be detected when using the binary of the NAVDB (a format also serving as input for the FM).

Known tools propose identifying gross deviations when the analyses are proposed only for the A424 source, or else gross deviations and some induced modifications when the analyses are conducted on the binary format.

In accordance with the A424 standard, a procedure is made up of a “procedure” record that references elements (for example fixed points or beacons) defined at other places in the database. A modification is referred to as direct when the procedure has its structure or its direct data modified. A modification is referred to as induced or indirect when it is one of the constituent records that is modified without the “procedure” record itself being modified (independently of a modification of the page in question). Known analyses will generally conclude that there is no modification of the “procedure”.

At present, various analysis tools are marketed. One equipment manufacturer proposes a tool for consulting the gross content of each database before and after modification. Another tool proposes a tool for visualizing deviations by group (depth analysis 1). One provider proposes a consultation tool for comparing the two binaries that is parameterizable, in particular in regard to the elements to be compared and the detection thresholds for the modifications. Airlines generally have their own tools. A software product is marketed that allows Arinc424 decoding, visualization and mapping of data.

There are many technical obstacles for the analysis of updates of databases. The volumes of data present in the database or used by airlines are significant. Identification of any modifications is difficult. It is also difficult to know what data modification will have an operational impact in flight, and if so to what extent. Analyses are generally performed only partially (the only statutory obligation relates to RNP-AR procedures). Analyses take a long time and interpretations are very difficult (there is sometimes a need for a flight simulator in order to understand the operational impact).

The patent literature does not describe satisfactory solutions to the problems described above, and in particular in respect of the comparisons between onboard databases.

### SUMMARY OF THE INVENTION

The document describes computer-implemented devices and methods for analyzing navigation databases, the method comprising the steps of: comparing two databases, associated with different update dates and/or sources, and determining a list ΔP, of length K, of different procedures between said databases; describing one (or at least one, or more, or each) of these procedures by way of N distinct flight cases, said N flight cases corresponding to various (individualized) combinations of variations of values of flight parameters, by varying in particular performance parameters, weather parameters and/or speed parameters; in an aeronautical computer of FMS type, determining, for one (or more or each) of the N flight cases, one or more flyable trajectories associated with one (or more or each) procedure from ΔP (therefore K×N×2 trajectories may be generated). Developments describe the determination of operational impacts associated with avionic trajectories, machine learning methods, analyses of deviations by trajectory, by procedure or by deviations between procedures. Aspects of software and of systems are described.

The comparison of two databases allows identification of a list ΔP of K different procedures. K denotes the total number of different procedures. One or each procedure from this list of size K is described by N flight cases. These N flight cases will thus generate 2×N trajectories per procedure: N for the first database and N for the second. A trajectory may be defined using: b=1 or 2 depending on the database; 1<=i<=K, with i referencing the procedure, and 1<=j<=N with j referencing the flight case.

Using different numbering, a flight case may be called UC (acronym for “use case”) and then the various flight declinations (individualized combinations, by varying flight parameters) may be called UCᵢ (with 1<=j<=N).

The document describes systems and methods for speeding up (e.g. assisting the operator in) impact analysis for an update of a NAVDB navigation database.

The systems and methods describe how to detect deviations between databases, and in particular the “operational” impact of an update of a NAVDB navigation database, that is to say on the consequences on FMS trajectories (analysis of the validation of the FM) or NAVDB flight procedures, for example. In that respect, the embodiments of the invention are advantageous for different audiences: engineers in charge of validating a flight management system and pilots or airlines for translating the various consequences caused by navigation database modifications into flight operations.

The embodiments of the invention may be advantageous for many industrial players, in particular airlines (flight analysis services), for equipment manufacturers supplying flight management systems FMS (e.g. developments, tests, FM actualization validation, for actualizing and exhibiting FM, etc.), for navigation data providers (for actualizing, securing the codings proposed in the databases), for procedure designers, etc.

Advantageously according to the invention, the “results” (the operational impacts) may be known quickly, from receipt of the update of the new database by the airline, and in a personalized manner (impacts focused on data specific to the operator or the airline).

### BRIEF DESCRIPTION OF THE DRAWINGS

Other features and advantages of the invention will become apparent from the description that follows and from the figures of the appended drawings, in which:

FIG. 1 shows examples of steps according to an embodiment of the invention;

FIG. 2 shows the structuring of the objects manipulated by the invention (procedures, trajectories, flight characteristics);

FIG. 3 shows the structuring of the objects manipulated for a cycle;

FIG. 4 shows an analysis by trajectory;

FIG. 5 shows an analysis by procedure;

FIG. 6 shows an analysis by deviations between procedures.

### DETAILED DESCRIPTION

### Aircraft

According to the embodiments of the invention, an “aircraft” may be a drone or a commercial aircraft or an airfreighter or even a helicopter, either carrying or not carrying passengers. More generally, the term “aircraft” in the description below may be replaced by the terms vehicle, automobile, truck, bus, train, motorcycle, boat, robot, submarine, etc., or any other element capable of being remotely controlled (by radio, satellite or other link), at least partially (intermittently, or periodically, or even conveniently over time). More generally, the term aircraft denotes any vehicle using a navigation database (set of constraints) coupled to a system for managing the movement of the vehicle.

### Anomalies or “Deviations”

Manipulated trajectories may be of various natures. Manipulated trajectories may be “real” (e.g. current, historical) trajectories and/or may be descended from “virtual” (e.g. simulated, likely, computed, etc.) trajectories. More generally still, trajectories manipulated by the invention may be 3D (3 spatial dimensions) trajectories, but also N-dimensional trajectories. For example, trajectories may be 4D (3D plus time), 5D with the fuel, 6D with the weather, etc., trajectories. An anomaly may relate to one or more of these dimensions or parameters.

Anomalies manipulated by the invention may be of various natures. Anomalies may be trajectory anomalies, which may be indicative of a certain number of underlying problems. A wide diversity of anomalies are possible (unnecessary lateral loop, thrust mode selected for a very short time, unnecessary airbrake inputs/outputs, etc).

Within the context of the invention, manipulated anomalies are mainly different procedures, and/or anomalies and/or trajectory deviations. Downstream of the method according to the invention, some advantageous embodiments comprise in particular the sale of trajectory validation services. These analyses of operational impacts caused by navigation database updates may be associated with other types of analyses. In-depth studies may be useful to a wide diversity of players, for example to the designer of aeronautical procedures, to A424 providers, to airlines (analysis of database cycles, opening of routes, analysis of pilot behaviors, analysis of instructions from air traffic control, e.g. detection of abnormal or suspect behaviors, analysis of fuel consumptions for real flights, etc.).

In one embodiment, detected anomalies are stored for later reference. An anomaly may be associated with numerous metadata: nature of the anomaly, quantitative aspects (numerical aspects, static and/or dynamic values, e.g. drifts, etc.), condition (e.g. suspicion, denied, confirmed, proved), relationships (e.g. root cause, third-party causal relationships or correlations, etc.).

In one embodiment, anomalies are stored in a blockchain (e.g. simulated, proved, “true” anomalies, as agreed by consensus distributed among the pilot, the company and ATC, for example).

### <<Big Data>>

The expression “Big Data” denotes the collection and analysis of data performed on a massive scale. This concept is associated with characteristics of technical nature, comprising: volume (e.g. large collections of data, even if they are redundant), variety (e.g. many different sources are used), velocity (e.g. the data are “fresh” or constantly updated in changing or dynamic environments), attesting to a certain veracity (e.g. weak signals drowned in noise are not suppressed and may consequently be detected or amplified), in order to finally represent a certain value (for example usefulness from the technical and/or professional, i.e. business, point of view). The present invention significantly reinforces the characteristics of velocity and veracity of the data (data that are fresh or valid, not obsolete or otherwise dated).

A computer-implemented method for analyzing navigation databases is described, the method comprising the steps of: comparing two databases, associated with different update dates and/or sources, and determining a list ΔP, of length K, of different procedures between said databases; describing one or more or each of these procedures by way of N distinct flight cases, said flight cases corresponding to various combinations of variations of values of flight parameters, by varying in particular performance parameters, weather parameters and/or speed parameters; in an aeronautical computer of FMS type, determining, for one (or more or each) flight case, one or more flyable trajectories associated with one (or more or each) procedure from the list ΔP.

The invention may be applied to the analysis of one and the same database (distinct update dates).

In one embodiment, work is carried out more systematically by increasing coverage of the space of the possible trajectories. Typically, more than 30 000 distinct flight cases may be considered, that is to say simulated, in order to record the operational impacts on a 28-day Airac cycle. What has been able to be accomplished manually on a very small scale is systematized here (automation by generation and number of trajectory possibilities) and furthermore incorporates execution of the operation of avionic systems (the flight case is entered into an FM).

The invention may relate, more generally still, to the comparison of two databases associated with different update dates and/or sources. In one embodiment, any two navigation databases may be compared with one another. The navigation databases may derive from different providers, or may be dated differently for one and the same provider (e.g. versions). For example, a database (n-8) may be compared with a database (n-2). This may be advantageous for specific analyses (analysis of incidents, investigations a posteriori, etc.).

In one embodiment, the analysis is incremental, i.e. two successive databases are compared with one another. In one embodiment, the two databases are those from two successive Airac cycles (the last database is the more up-to-date, current, whereas the database (n-1) is the previous database).

Moreover, the embodiments of the invention allow the (navigation database/navigation system) coupling to be tested. For example, in a dual system, it may be desirable to compare left-hand FMS and right-hand FMS. It is also possible to test a database in accordance with two different FMS versions.

The step of generating various combinations of avionic data parameters or flight parameters (by varying in particular the performance parameters, weather parameters and/or speed parameters/that is to say the characteristics making up the flight trajectory of an aircraft) is aimed at “optimum paving” of the space of the possible trajectories. To put it another way, the tests are systematized as far as possible, and are comparatively more complete than what is done today.

In one development, the method moreover comprises the step of determining a score for one (or more or each) procedure ΔPᵢ from ΔP, said score being representative of the associated operational impact.

The modifications between various versions are supposed to be negligible. In reality, the operational impacts may be significant. Renaming an airport may have no impact at all. On the other hand, a small change may bring about large changes (new approach procedure).

Operational impacts may be predefined, for example by categories (new diversion, new runway, etc.). In one specific embodiment, the operational impact of a deviation (an element from the list of different procedures between databases) is evaluated using various methods. In one specific embodiment, the step of analyzing the operational impact of a detected deviation comprises the step of determining a score associated with said deviation. This step may for example use an analytical function (e.g with coefficients or weightings), systems of equations, or may even result from the execution of an algorithm (algorithmic definition of the score).

In one development, said score is learnt by machine learning, the training data comprising the flyable trajectories at the input and associated scores at the output.

The “score” (associated with a deviation) is therefore either a human annotation on a case-by-case basis or a result “learnt” by the machine as the annotations accumulate.

In one development, a deviation is determined by unsupervised classification.

The unsupervised classification or “unsupervised clustering” methods comprise in particular data partitioning. Data partitioning (or data clustering) is a method of analyzing data. It is aimed at dividing a set of data into various homogeneous groups so that the data in each group share common properties. There are multiple data partitioning methods, including centroid-based methods such as the k-means or k-medoids algorithms; hierarchic grouping methods; expectation maximization (EM) algorithms; density-based algorithms such as DBSCAN or OPTICS; connectionist methods such as self-adaptive maps.

It is possible to use a proximity (similarity) criterion by introducing measurements or classes of distance between objects. A partitioning may be aimed at maximizing intra-class inertia (in order to obtain homogeneous groups) and/or at maximizing inter-class inertia (so as to obtain well differentiated subassemblies).

In other embodiments, the partitioning is hierarchic or dendrogram “clustering”.

The fact that the classification is unsupervised means that “machine learning” techniques will allow certain similarities to be found in order to be able to classify the data. This type of analysis makes it possible to have a profile of the various groups. This therefore allows simplification of the analysis of the data by highlighting the common points and the differences and by thus reducing the number of variables for the data.

In one development, the method comprises a step of detecting one or more anomalies in one or more trajectories by way of unsupervised classification.

In one embodiment, the method comprises a step of detecting one or more abnormal trajectories by way of unsupervised classification (130).

An “anomaly” may correspond to an excessive score.

In data exploration, anomaly detection (or “outlier detection”) is the identification of rare elements, events or observations that arouse suspicion by differing significantly from the majority of the other data. There are three major categories of anomaly detection techniques: techniques referred to as unsupervised, techniques referred to as supervised and semi-supervised techniques.

In more detail, the unsupervised anomaly detection techniques detect the anomalies in a set of untagged data. In general, it is assumed that the majority of data are normal and the deviant data are sought. The supervised anomaly detection techniques operate on data that are tagged or labelled or otherwise annotated (according to binary discretizations, e.g normal or abnormal, or quantified e.g. scores). These techniques involve training a “classifier”. In machine learning, the term (linear) classifier denotes statistical classification algorithms. A classifier aims to classify samples having similar properties, measured on observations, into classes. A linear classifier is a particular type of classifier operating by linearly combining the samples.

The anomaly detection techniques comprise one or more of the techniques comprising: a density-based technique (for example the k nearest neighbors method, the “local outlier factor” method), a support vector machine (with one class); a recurrent neural network; an autoencoder; one or more Bayesian networks; hidden Markov models; analyses by data partitioning; by deviation from association rules; fuzzy logic or set machine learning techniques.

In one development, the deviations are determined by trajectory (or between trajectories). This type of analysis is advantageous for an FMS design engineer. The benefit of an analysis by LOF (local outlier factor) is that this analysis produces a grade between 0 and 1, not just a binary response (for example 0 means that there is no impact, e.g. simple name change).

In one development, the deviations are determined by procedure (or between procedures). This type of analysis is advantageous for the pilot. Score functions are used to establish the scores relating to the procedures that will then be organized during the presentation of the final results (score procedures)/display link.

In one development, the deviations are determined by deviations between procedures (or between deviations between procedures).

The “Big Data” analysis methods used may be made up of an innovative combination of “score functions” relating to the previous elements (criteria, procedures, trajectories, deviations, and so on), and consolidated for each type of analysis, resulting in the allocation of a score for each object of study from the associated analysis. Such analyses may be conducted on the trajectories (clustering, LOF (Local Outlier Factor), and so on), on the bundles of trajectories per procedure (LOF, and so on). “Performance variability” analyses (LOF relating to the procedures for anomaly detection for the variability of the performance of the procedure).

Analyses may be conducted for the variations of bundles of trajectories per procedure (“evolution mean” or the mean of the evolutions relating to the various criteria and “evolution spread” or the standard deviation of the evolutions). Finally, various analyses of trajectories or of verification of trajectories may be determined.

In one development, the two navigation databases are NAVDB navigation databases of one and the same AIRAC cycle.

In one development, one or more of intermediate computation results, in particular one or more deviations and/or scores and/or anomalies, information relating to the root causes and/or the computation context of the steps of the method, is the subject of a display in a human-machine interface.

In one development, the method moreover comprises displaying the results of the cost functions applied to the K procedures in a manner adapted to suit the user.

The adaptation of the display to suit the user may be configurable in various ways, in particular in terms of criteria, data to be monitored, filters (emphasis by codes warning of the deviations between multiple instances or versions, menus allowing past analyses to be traced back and the delta to be found with present analyses, for example in the form of statistics, etc.).

The steps of displaying may be adapted to suit the user, in particular by presenting results of the cost functions applied to the K procedures, this display allowing the user to view these deviations synthetically: display according to customary criteria (distance, etc.), according to a classification related to the cost functions that is used (complex criteria). The display may allow the user to be assisted in his management of the analyses. In one embodiment, a synthetic display of instrument panel type provides access to a display presenting the classifications as a whole or after filtering, followed by the detailed display on demand concerning the impact of the modifications of the NAVDB.

The human-machine interaction is discussed below. A method according to the invention may comprise one or more feedback loops (e.g. downstream retroacting on the upstream, feedforward, etc.). A feedback loop may be “closed” that is to say inaccessible to human control (it is run by the machine). It may be “open” (e.g. step of displaying in a human-machine interface, validation or any other system of human confirmation). Various embodiments may result in different implementations by closing or opening one or more open or closed loops, respectively. For example, the method according to the invention may involve only open feedback loops (i.e. the pilot intervenes at every stage), or only closed feedback loops (e.g. complete automation), or else a combination of the two (the human contribution being variable or configurable). As such, the method (which may be an “artificial intelligence” method) may be interpreted as being “transparent”, in that it is controllable. The display may regard intermediate results of computations, information relating to the root causes and/or to the computing context. As such, the method may be considered to be “explainable”.

In one development, the method moreover comprises the step of superimposing the displays associated with the trajectories before and after the navigation database is updated.

Other analyses may be implemented, in particular by considering the graphical properties of the trajectories under consideration (e.g. point density, shapes, comparison of the surface areas or the areas between the trajectories, etc.). The trajectories may be compared according to various predefined criteria (comprising in particular the number of changes of course, the number of segments, the distribution of these segments in space, the distribution of the flight segments according to their length).

In one development, the display allows the operator to select or indicate that a procedure is acceptable, or otherwise. There may be provision for input means for feedback.

In one development, the display highlights the new procedures, the modified procedures and/or the removed procedures and/or input peripherals allow indication of whether or not a selected procedure is verified, and if so whether or not it is acceptable.

In one development, the method moreover comprises the application of one or more data filters, the application of one or more filters applied to the data (e.g.

thresholding, normalization, etc.) and/or to the display thereof (e.g. personalization, spotlighting, etc.), said filters being configurable.

In one embodiment, the method comprises the application of one or more whitelists and/or blacklists of data or data types.

For example, the whitelists may comprise data types or data that it is important to monitor. The blacklists correspond to the data or data types of data that may be ignored.

In one development, a navigation database is a NAVDB navigation database, a DAFIF database, a terrain database or an obstacle or cultural database.

A computer program product is described, said computer program comprising code instructions allowing one or more of the steps of the method to be carried out when said program is executed on a computer.

A system for analyzing aircraft trajectories is described, the system comprising means for implementing one or more of the steps of the method.

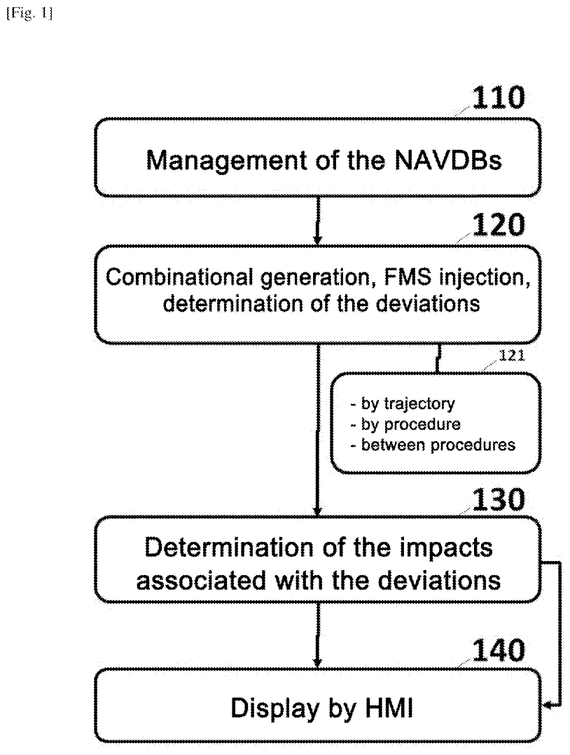

FIG. 1 shows examples of steps according to an embodiment of the invention.

With regard to navigation databases 110, one or more deviations 120 are determined by using in particular generations of flyable trajectories (that is to say produced by FM methods and systems), and then operational impacts 130 are determined. Finally, various displays with an explanatory aim 140 may be implemented (human-machine interface, acronym HMI).

In one embodiment, the method comprises the steps of defining a processing chain for defining the impact of the evolutions in navigation databases; detecting the modification of the source; simulating trajectories; defining and adjusting predefined cost or score functions; analyzing trajectories, according to the appropriate cost functions, in order to define the impact of the evolutions in the database reference on the whole system; optionally displaying results (e.g. associated with the current database) or deviations related to the evolutions in the database, organized according to the personalized cost criteria.

Display 140 of the results is an optional but advantageous step that may allow for example the list of procedures to be organized according to their score after processing by way of the score function. The advantage associated with these displays lies in the fact that they explain the logical routing for the operational analysis of the impacts of the evolutions in procedure between cycles. In other words, the user may be guided (actively) in his analysis, or the latter may be facilitated (passively). The displays of the intermediate results may contribute to assisting the user in organizing his analyses in order to identify cases having great operational impacts.

Among the functionalities associated with the display, it is in particular possible to restrict the analyses to particular aspects or data. In one embodiment where the display is chopped into a plurality of “layers” of information, for example by way of abstraction levels, a first layer may for example present information macroscopically or synthetically (e.g counters, mapping, synthesis, application of filters, etc.), a second level may present results exhaustively (e.g. list of procedures, list of procedures exhibiting a modification between two NAVDB cycles, sorting and filtering possibilities on the presented fields, and on the computed scores, etc.). A third level may consist in an operational presentation, that is to say displaying the trajectories of the cycle under consideration and/or before and after update.

Various visualization and navigation means may be used (e.g. touchscreens, virtual reality, augmented reality, video projection, holograms, haptics, dataglove, etc).

In detail, the method may comprise one or more of the steps described below.

In one embodiment of the invention, the method comprises the step of receiving data from the NAVDB navigation database (step of reading, statistical counting of the elements of the database, etc). In an initial cycle, the list of elements on which to compute the trajectories is drawn up. The elements needed for computing the trajectories are extracted. The complete departure and arrival procedures (operation called stringing in the FMS) are built. These procedures are analyzed.

The iterative (delta) cycle moreover comprises the steps of:

i) determining one or more contextual deviations between two NAVDB navigation databases; this step may comprise one or more substeps, in particular: detecting or determining deviations referred to as “gross” (by way of addition and/or removal and/or modification of data); detecting or determining recursive deviations (a datum is referred to as “deviant” if one of its constituent elements has undergone a modification). One or more of these steps may be in depth; for example certain types of data to be analyzed may be selected; whitelists or blacklists may be predefined (e.g. ignoring a name change for an airport); application of thresholds or of ranges of thresholds (for example not noting the deviation if the change of CRS is <1*), application of predefined logic rules, etc.);

ii) drawing up the list of elements to be compared (this may contain the modified, removed and/or new elements); this step may comprise one or more substeps, in particular the step of extracting elements (or data) needed for computing trajectories and for building one or more complete departure and/or arrival procedures (these operations are called stringing in the FMS).

In one embodiment of the invention, the method comprises a step of retrieving or determining counters and/or deviations that are not useful for computing the trajectories, but that are useful for the final display. The subject of the display may also be the display of statistics and/or deviations relating to one or more of the databases of the cycle and/or relating to the delta (the difference) between the databases of a cycle.

In one embodiment of the invention, one or more operational impacts associated with one or more deviations may be determined (or computed or simulated or inferred).

In one embodiment, per procedure, each procedure is described by N trajectories (“N flight cases”), for example in a combinational manner. Various types of massive generation are possible. In one embodiment, the trajectories are obtained by varying a plurality of factors, in particular the performance of the aircraft (so as to cover the operational flight area), the various methods of flying (choice of speeds, cost indexes and so on), and/or by varying the various parameters influencing the trajectory of an aircraft (e.g. weather, temperature, mass of the airplane, condition of the airplane). In this way, a large number of trajectories may be generated. These generated trajectories are referred to as “flyable”, i.e. of FMS type, and therefore complying with the standards relating to navigation performance (RNP) D0236/D0283, and exploiting the variations in all operational parameters.

In one specific embodiment, a generic FMS may be used to compute the flight plans and the trajectories (the trajectories presented will have a very high degree of similarity with what is presented to the pilot as the flight progresses).

Advantageously, massive generation allows coverage of all possible operations of the airline, in particular the use of departure and arrival procedures within the context of PBN (“Performance Based Navigation”), while taking into account the internal constraints of the NAVDB and the constraints related to performance through the use of the FMS. It is noteworthy that these trajectories are different than those proposed by the ground tools of the operational control centers (OCC).

In the case of the comparison of two navigation databases, the combination may consist in computing a number of trajectories equal to twice the number of elements to be compared, multiplied by the N flight cases.

In one specific embodiment, the operational impact of a deviation is evaluated, using various methods. In one specific embodiment, the step of analyzing the operational impact of a detected deviation comprises the step of determining a score associated with said deviation. This step may for example use an analytical function (e.g with coefficients or weightings), systems of equations, or else may result from the execution of an algorithm (algorithmic definition of the score).

The procedures and trajectories may be determined and then evaluated, using various methods referred to as Big Data and/or machine learning (below).

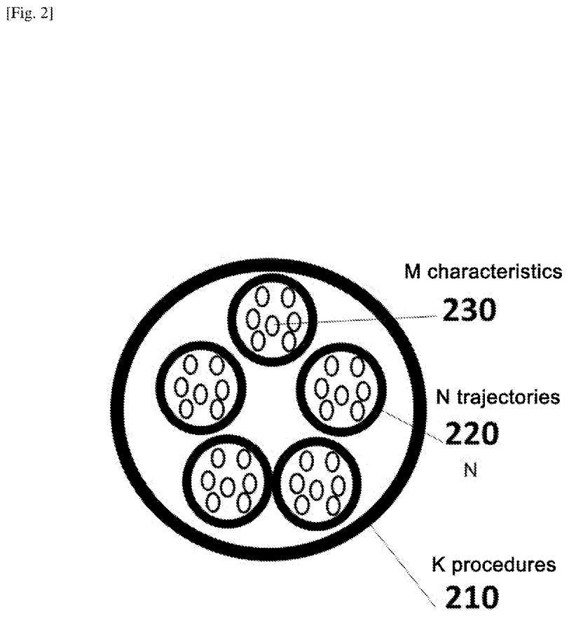

In one embodiment, a plurality of types of analysis (or “steps”) may be carried out in order to carry out the analysis of a new cycle C2. The outputs of these analyses may be combined in order to provide a measure (quantification) of anomaly for the components of the current cycle.

[FIG. 2] shows the structuring of the objects manipulated for a procedure.

N (220) denotes the number of trajectories per procedure.

M (230) denotes the number of characteristics per trajectory (these characteristics may be geometric parameters defined by FMS experts that describe the nature of and evolution in each of these trajectories from an operational point of view.

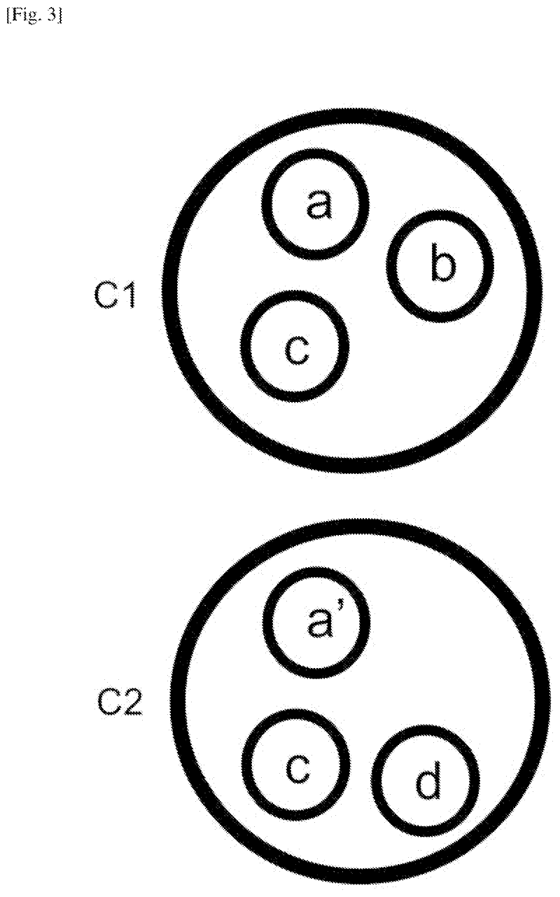

In the example shown, K=1, N=5 and M=7.

[FIG. 3] shows the structuring of the objects manipulated for a cycle.

For an AIRAC cycle (C1 and C2 differ from C1), K1 and K2 denote the numbers of procedures.

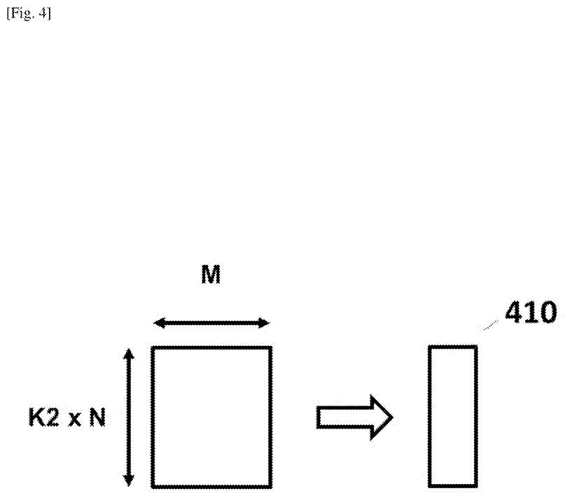

The characteristic a is modified to produce a′, the characteristic b is removed, the characteristic c is unchanged and the characteristic d is new.

[FIG. 4] shows an analysis by trajectory.

K1 denotes the number of procedures for the database (n-1); K2 denotes the number of procedures for the database (n); N denotes the number of flight cases: K1×N scores may be determined for the database (n-1) and K2×N scores may be determined for the database (n).

In the matrix of dimensions [K2×N, M], K2 (210) denotes the number of procedures, N (220) denotes the number of trajectories per procedure, M (230) denotes the number of characteristics per trajectory. The object of study is a matrix of dimensions (410) [K2×N, M], where all of the characteristics of the trajectories are computed.

In other words, for the elements “trajectories”, the object of study is a matrix of size [K2×N, M]. Each row derives from a single trajectory of C2.

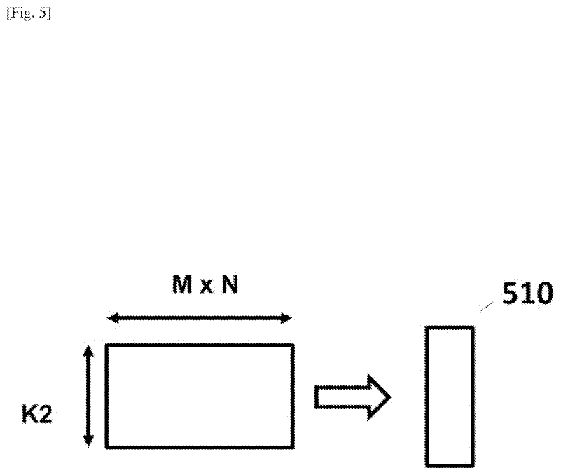

Algorithms of unsupervised clustering and anomaly detection such as LOF are applied to this matrix in order to associate with each trajectory a measure of its degree of anomaly compared to all generated trajectories. Each procedure among the K2 procedures of (n) then contains N anomaly scores, which may be grouped to create one anomaly score per procedure.

[FIG. 5] shows an analysis by procedure.

K2 denotes the number of procedures in the database (n). In the matrix [K2, M×N], K2 denotes the number of procedures and the product M×N equals M the number of characteristics per trajectory multiplied by N the number of trajectories per procedure, or the total number of characteristics per procedure. The object of study (510) is a matrix of dimensions [K2, M×N], where all of the characteristics of the trajectories are computed.

For each procedure, the characteristics of the trajectories of which it consists are concatenated.

In other words, for the elements “bundle of trajectories per procedure”, the object of study is a matrix. For each procedure, a vector is computed. Each vector derives from a quantity N of trajectories. These are the trajectories corresponding to each flight case of the procedure being studied.

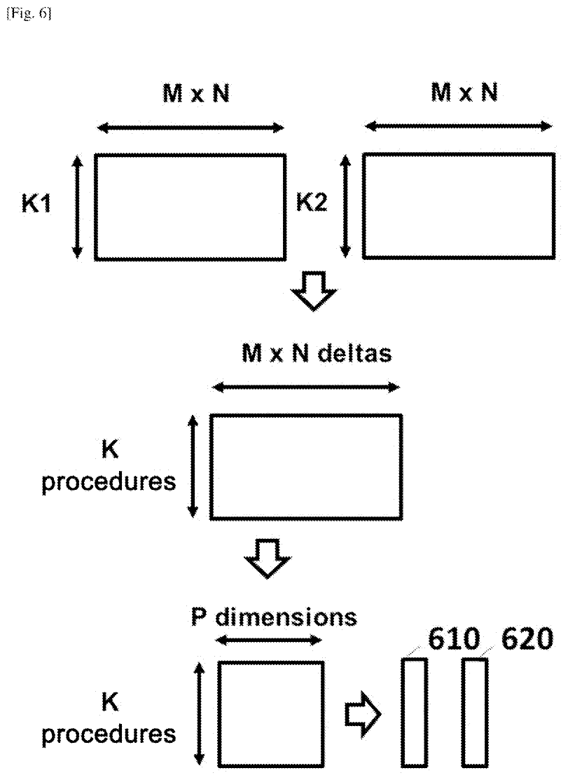

Algorithms of clustering and anomaly detection may be applied to this new matrix in order to associate with each procedure a score reflecting the degree of anomaly of the variation of its trajectories in comparison with the other procedures. Each procedure among the K2 procedures of (n) thus has an anomaly score.

[FIG. 6] shows an analysis by deviation between procedures.

K1 denotes the number of procedures in the cycle (n-1) and K2 denotes the number of procedures in the cycle (n). K denotes the number of procedures modified between the cycles (n-1) and (n), which may lead to distinct operational consequences.

For this analysis, the characteristics of the trajectories of the procedures of the current cycle are compared with the characteristics of the trajectories of the procedures of the previous cycle. These deviations between procedures of the current and previous cycles may be determined, and then these deviations may be associated with operational impacts, in reference to previously defined operational impacts.

In one embodiment, the current and previous matrices are subtracted from one another: the difference matrix is determined. This difference matrix is projected into a space of dimensions P<M×N, allowing transformation of the differences of correlated characteristics into a set of decorrelated variables. In one embodiment, the statistical moments (such as the sum and the standard deviation) of these decorrelated variables for each procedure provide two new measures for deviations: the evolution mean 610 and the evolution standard deviation (“evolution spread”) 620.

In other words, for the elements “variation of bundle of trajectories per procedure”, the object of study is the difference in the characteristics deriving from the trajectories of the procedures modified between the cycles (n) and (n-1). For each procedure from the list ΔP, 2*N trajectories are generated: N for the cycle (n) and N for the cycle (n-1).

In one embodiment, the combination of the various scores (score 1, score 2, evolution mean, evolution standard deviation) allows a measure (a quantification) to be obtained for detecting one or more procedure anomalies. Advantageously, this detection is adapted and parameterizable.

A method for computing the deviation between two navigation databases (BDD) explaining the impact of the evolution between the two BDDs on the trajectories, according to defined cost functions and criteria, comprising the steps of: determining the deviations between 2 Arinc424 navigation databases; determining a list of procedures to be compared (SID departure procedures, and so on); determining a list of N flight cases (performance, mass, weather, cost index, speed and so on) per procedure; inserting the list of elements into a generic FMS for the two databases; using the generic FMS to compute trajectories associated with each procedure to be compared.

In one development, the method moreover comprises the step of defining descriptive characteristics of related trajectories, with complex cost functions, in particular by choosing the criteria and the scoring functions, by defining the criteria in particular for measuring deviations and by implementing machine learning algorithms in order to output a grade for the LOF.

In one development, the method moreover comprises detecting anomalies in the trajectories and procedures, using algorithms of clustering and anomaly detection on the descriptive characteristics of the trajectories and the procedures; and combining the results of these algorithms to strengthen the robustness of the anomaly detection.

In one development, the method moreover comprises measuring deviations between procedures, by projecting the matrix of distances between procedures into a space having the decorrelated dimensions in order to characterize the difference in and the variability of a procedure between two cycles.

In one development, the method moreover comprises displaying the results of the cost functions applied to the K procedures in a manner adapted to suit the user.

In one embodiment, the invention generates variations of the elements making up the trajectories (in order to pave the space of the possible trajectories completely), which are validated by a certified FMS in order to provide flyable trajectories. Deviations are measured between these flyable trajectories, and then possibly and selectively displayed to the pilot.

The present invention may be implemented on the basis of hardware and/or software elements. It may be available as a computer program product on a computer-readable medium. The medium may be electronic, magnetic, optical or electromagnetic.

According to the embodiments of the invention, the location in which the computations are performed may be varied: at the present time, both local (onboard) and remotely accessed (cloud) resources may be mobilized. It is also legitimate to think that very significant computing means may—or will eventually be able to—be located onboard (server rack, PC, tablets, smartphones, VR headsets, etc.).

In one embodiment, an aircraft is equipped with a module for communicating and collaboratively sharing data output from the computers aboard the aircraft. This hardware module may be in communication with various users and/or providers of data. On the ground, computing resources may be important (e.g. elastic cloud).

In terms of hardware, the embodiments of the invention may be carried out by computer. The computer may be a rack or a tablet or an EFB or a software package integrated in the FMS, etc. The architecture may be distributed, and for example of the “cloud computing” type. Peer-to-peer servers, completely or partially distributed (existence of centers), may interact. There may be one or more privileged nodes when private cloud or private blockchain is involved. The access may be multiplatform (e.g. from EFB, web app, ground access, etc.). One or more EFBs may interact with one or more FMSs to manage computations. Computing and/or memory resources may be accessed locally and/or remotely in order to implement the steps of the method.

1. A computer-implemented method for analyzing navigation databases, the method comprising the steps of:
comparing two navigation databases, associated with different update dates and/or sources, and determining a list of different procedures, or deviations, between said databases;
characterizing one procedure from this list by way of distinct flight cases, said flight cases corresponding to various combinations of variations of values of flight parameters, the flight parameters comprising in particular performance parameters, weather parameters and/or speed parameters; and
in an aeronautical computer, for example of FMS type, generating trajectories associated with the flight cases of the different procedures between the two navigation databases.

2. The method as claimed in claim 1, further comprising the step of determining a score, said score being representative of the operational impact associated with said deviations.

3. The method as claimed in claim 2, wherein said score being learnt by machine learning, the training data comprising the flyable trajectories at the input and associated scores at the output.

4. The method as claimed in claim 2 any one of the preceding claims, wherein a deviation being determined by unsupervised classification.

5. The method as claimed in claim 2, wherein the deviations being determined by trajectory.

6. The method as claimed in claim 2, wherein the deviations being determined by procedure.

7. The method as claimed in claim 2, wherein the deviations being determined by deviations between procedures.

8. The method as claimed in claim 1, wherein the two navigation databases being NAVDB navigation databases of one and the same AIRAC cycle, or being any two navigation databases, or even being distinct versions of FM.

9. The method as claimed in claim 1, preceding claims, wherein one or more of the intermediate computation results, in particular one or more deviations and/or scores and/or anomalies, information relating to the root causes and/or the computation context of the steps of the method, is the subject of a display in a human-machine interface.

10. The method as claimed in claim 9, further comprising the step of superimposing the displays associated with the trajectories before and after the navigation database is updated.

11. The method as claimed in claim 9, wherein the display highlights the new procedures, the modified procedures and/or the removed procedures and/or wherein input peripherals allow indication of whether or not a selected procedure is verified, and if so whether or not it is acceptable.

12. The method as claimed in claim 9, further comprising the application of one or more filters applied to the data and/or to the display thereof, said filters being configurable.

13. The method as claimed in claim 8 any one of the preceding claims, wherein a navigation database being a NAVDB navigation database, a DAFIF database, a terrain database or an obstacle or cultural database.

14. A computer program product, said computer program comprising code instructions allowing the steps of the method as claimed in claim 13, to be carried out when said program is executed on a computer.

15. A system for analyzing aircraft trajectories, the system comprising computing and/or memory resources, which are accessed locally and/or remotely, in order to implement the steps of the method as claimed in claim 13.
